(19) United States
(12) Patent Application Publication
(10) Pub. No.: US 2020/0090223 A1
(43) Pub. Date: Mar. 19, 2020

(54) INFORMATION PROCESSING DEVICE, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Masahiro MISAKI, Nagoya-shi (JP); Orie MITSUHASHI, Kasugai-shi (JP); Masahiro UEDA, Nisshin-shi (JP); Yoshitaka ATSUMI, Toyota-shi (JP); Naoto SASAGAWA, Nishio-shi (JP); Naoki YAMAMURO, Nagoya-shi (JP); Chiho OGAWA, Toyota-shi (JP)

(73) Assignee: TOYOTA JIDOSHA KABUSHIKI KAISHA, Toyota-shi (JP)

(21) Appl. No.: 16/575,455

(22) Filed: Sep. 19, 2019

(30) Foreign Application Priority Data
Sep. 19, 2018 (JP) 2018-174873

(51) Int. Cl. G06Q 30/02; G07C 5/00; G01C 21/36

(52) U.S. Cl. CPC G06Q 30/0261; G01C 21/3697; G06Q 30/0259; G07C 5/006

(57) ABSTRACT

The present disclosure provides an information processing device capable of promoting to guide a user riding in a vehicle to a predetermined maintenance shop according to a state of the vehicle. The information processing device is provided with a controller which executes: obtaining predetermined service information including an advertisement; obtaining predetermined user information on a maintenance state of a vehicle in which the user rides; extracting, based on the user information, distribution information which is the service information about the predetermined maintenance shop, and which matches the user among the service information; and transmitting the distribution information to an on-board device of the vehicle based on position information of the vehicle.

### CROSS REFERENCE TO THE RELATED APPLICATION

This application claims the benefit of Japanese Patent Application No. 2018-174873, filed on Sep. 19, 2018, which is hereby incorporated by reference herein in its entirety.

### BACKGROUND

### Technical Field

The present disclosure relates to an information processing device, an information processing method, and a non-transitory storage medium.

### Description of the Related Art

In patent literature 1, there is disclosed a technique of providing information such as a vehicle inspection guide, etc., at a timing decided according to the state of a vehicle.

In patent literature 2, there is also disclosed a technique in which an information providing device mounted on a vehicle provides an occupant with only those which have been judged to be necessary according to the state of the vehicle among pieces of service information such as advertisements, etc., which have been received.

### CITATION LIST

### Patent Literature

Patent Literature 1: Japanese patent application laid-open publication No. 2002-230270

Patent Literature 2: Japanese patent application laid-open publication No. 2005-100155

### SUMMARY

The present disclosure has for its object to provide a technique that can promote to guide a user riding in a vehicle to a predetermined maintenance shop according to the state of the vehicle.

An information processing device according to the present disclosure may include a controller comprising at least one processor configured to execute:

obtaining predetermined service information including an advertisement;

obtaining predetermined user information on a maintenance state of a vehicle in which a user rides;

extracting, based on the user information, distribution information which is the service information about a predetermined maintenance shop, and which matches the user among the service information; and

transmitting the distribution information to an on-board device of the vehicle based on position information of the vehicle.

The present disclosure can also be grasped from the aspect of an information processing method. For example, the present disclosure may be an information processing method in which a computer executes:

a step of obtaining predetermined service information including an advertisement;

a step of obtaining predetermined user information on a maintenance state of a vehicle in which a user rides;

a step of extracting, based on the user information, distribution information which is the service information about a predetermined maintenance shop, and which matches the user among the service information; and

a step of transmitting the distribution information to an on-board device of the vehicle based on position information of the vehicle.

The present disclosure may be a non-transitory storage medium in which a program for making a computer execute such an information processing method is stored.

According to the present disclosure, it is possible to promote to guide a user riding in a vehicle to a predetermined maintenance shop according to the state of the vehicle.

### BRIEF DESCRIPTION OF THE DRAWINGS

FIG. 1 is a view illustrating the schematic configuration of an advertisement providing system according to an embodiment.

FIG. 2 is a view exemplifying the hardware configuration of each of an on-board device, a shop side terminal and a server device in an advertisement providing system.

FIG. 3 is a view exemplifying the functional configuration of the server device according to the embodiment.

FIG. 4A is a view illustrating an example of a service information table according to the embodiment.

FIG. 4B is a view illustrating an example of another service information table according to the embodiment.

FIG. 5 is a view illustrating an example of a user information table according to the embodiment.

FIG. 6 is a view illustrating an example of a distribution information table according to the embodiment.

FIG. 7 is a view for explaining a shop to which information is actually provided by a distribution information providing unit among those shops which send distribution information in a first embodiment.

FIG. 8 is a view illustrating an example in which advertisement information of an advertisement sent by the shop is displayed on a navigation screen included in an on-board device.

FIG. 9 is a view exemplifying an operation flow of an advertisement providing system according to the embodiment.

FIG. 10 is a view for explaining a shop to which information is actually provided by a distribution information providing unit among those shops which send distribution information in a second embodiment.

### DESCRIPTION OF THE EMBODIMENTS

In an information processing device which is one mode of the present disclosure, a controller may extract, among pieces of predetermined service information including advertisements, information (distribution information) which is information about a predetermined maintenance shop and which matches a user of a vehicle. At this time, the controller may extract the distribution information based on predetermined user information on the maintenance state of the vehicle in which the user rides. Here, the maintenance state of the vehicle is information on the current states of tires, a battery, lubricating oil, a brake system, etc., and the past maintenance status of the vehicle. Then, the controller may transmit the distribution information to an on-board device of the vehicle.

According to this, the information matching the user can be provided to the user. However, if the distribution information is only provided to the user as it is, there is a possibility that the user may not be fully promoted to go to the maintenance shop that sends the distribution information.

Accordingly, the controller may transmit the distribution information to the on-board device of the vehicle based on the position information of the vehicle. Specifically, the controller may transmit the distribution information on maintenance shops existing in a predetermined range from the current position of the vehicle to the on-board device. Here, the predetermined range is an area in which the user can stop or visit relatively easily, on the way to a destination. In addition, the controller may transmit distribution information on maintenance shops existing on a planned travel route of the vehicle set in advance to the on-board device.

According to this, the user will be provided with the information which matches the user, and which is relevant to the maintenance shops existing in the area where the user can visit relatively easily. Accordingly, the information processing device according to the present disclosure can promote to guide the user to a maintenance shop which sends service information matching the user.

Hereinafter, specific embodiments of the present disclosure will be described with reference to the drawings. The sizes, materials, shapes, relative layouts and the like of the components described in the following embodiments are not intended to limit the technical scope of the disclosure to these alone, unless otherwise specified.

### First Embodiment

### (System Configuration)

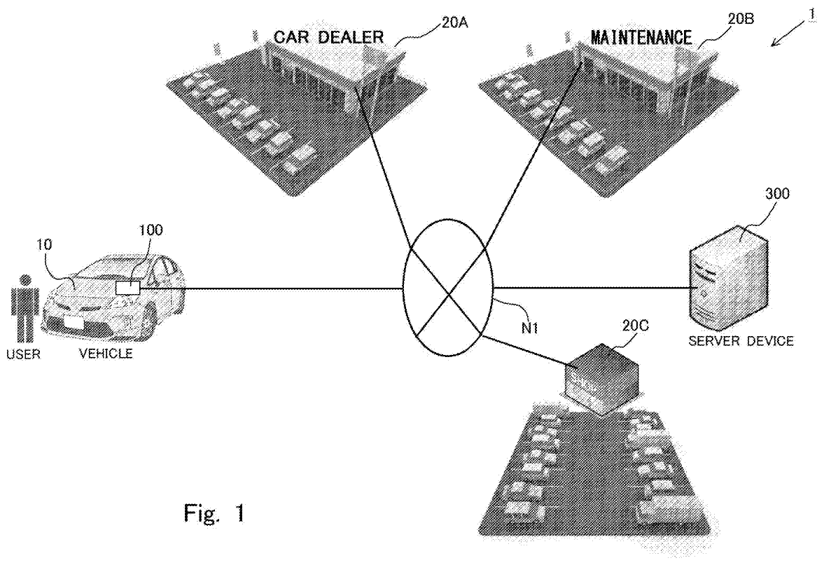

FIG. 1 is a diagram showing a schematic configuration of an advertisement providing system according to the present embodiment. In the example of FIG. 1, the advertisement providing system 1 includes a vehicle 10, shops 20A-20C, and a server device 300. The vehicle 10 is a vehicle in which a user who uses the advertisement providing system 1 rides, and includes an on-board device 100. Each of the shops 20A to 20C has a shop-side terminal 200.

In the advertisement providing system 1, the on-board device 100, the shop-side terminal 200, and the server device 300 are connected to each other via a network N1. For example, as the network N1, a wide area network (WAN), which is a worldwide public communication network such as the Internet, or other communication networks may be adopted. Furthermore, the network N1 may include a mobile communication network for mobile phones, or a wireless communication network such as Wi-Fi.

The clerk or the like of each of the shops 20A-20C can input predetermined service information including advertisements by using each of the shop-side terminals 200. In addition, predetermined user information relating to the maintenance state of the vehicle 10 can be input to the on-board device 100 via a sensor or the like described later. The information is transmitted to the server device 300 via the network N1.

The server device 300 executes a process of providing distribution information matching the user based on the information. Details of the processing will be described later.

### (Hardware Configuration)

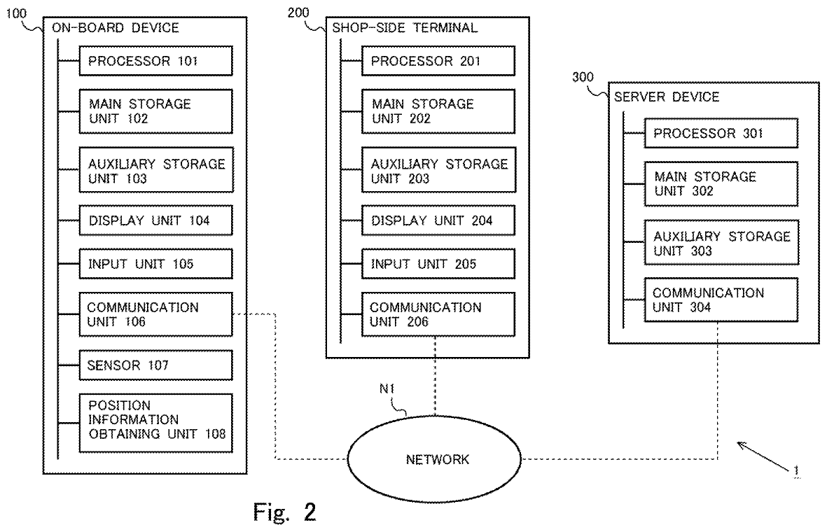

FIG. 2 is a diagram illustrating hardware configurations of the on-board device 100, the shop-side terminal 200, and the server device 300.

First, the server device 300 will be described. The server device 300 has a general computer configuration. The server device 300 includes a processor 301, a main storage unit 302, an auxiliary storage unit 303, and a communication unit 304. These are connected to each other by a bus. The main storage unit 302 and the auxiliary storage unit 303 are computer-readable recording media. The hardware configuration of the computer is not limited to the example shown in FIG. 2, and its components may be omitted, replaced, or added as appropriate.

In the server device 300, the processor 301 loads the program stored in the recording medium into the work area of the main storage unit 302, executes the program, and controls each of functional components and the like through the execution of the program, thereby realizing a function that matches a predetermined purpose.

The processor 301 is, for example, a CPU (Central Processing Unit) or a DSP (Digital Signal Processor). The processor 301 controls the server device 300 and performs various information processing operations. The main storage unit 302 includes, for example, a RAM (Random Access Memory) or a ROM (Read Only Memory). The auxiliary storage unit 303 is, for example, a EPROM (Erasable Programmable ROM) or a hard disk drive (HDD). The auxiliary storage unit 303 may include a removable medium, that is, a portable recording medium. The removable medium is, for example, a USB (Universal Serial Bus) memory or a disc recording medium such as a CD (Compact Disc) or a DVD (Digital Versatile Disc).

The auxiliary storage unit 303 stores various programs, various data, and various tables in a recording medium in a readable and writable manner. The auxiliary storage unit 303 stores an operating system (OS), various programs, various tables, and the like. The information stored in the auxiliary storage unit 303 may be stored in the main storage unit 302. The information stored in the main storage unit 302 may be stored in the auxiliary storage unit 303.

The communication unit 304 is connected to other devices and controls communication between the server device 300 and other devices. The communication unit 304 is, for example, a LAN (Local Area Network) interface board, and wireless communication circuits for wireless communication. The LAN interface board and the wireless communication circuit are connected to the network N1 such as the Internet, which is a public communication network.

The series of processing executed by the server device 300 may be executed by hardware or software.

Next, the on-board device 100 will be described. The on-board device 100 includes a processor 101, a main storage unit 102, an auxiliary storage unit 103, a display unit 104, an input unit 105, a communication unit 106, a sensor 107, and a position information obtaining unit 108. The processor 101, the main storage unit 102, and the auxiliary storage unit 103 are the same as the processor 301, the main storage unit 302, and the auxiliary storage unit 303 of the server device 300, and therefore descriptions thereof are omitted. The display unit 104 is, for example, an LCD (Liquid Crystal Display), an EL (Electroluminescence) panel, or the like. The input unit 105 includes a touch panel, a push button, and the like. The input unit 105 may include a camera that enables input of video or images or an input unit of sound such as a microphone. The communication unit 106 is communication means for connecting the vehicle 10 to the network. The communication unit 106 accesses the network N1 using, for example, a telephone communication network such as a cellular telephone or the like, or a radio communication such as the WiFi, and can perform communication with the server device 300 or the like.

The sensor 107 is a means for sensing the maintenance state of the vehicle 10. The sensor 107 senses the current state of, for example, a tire, a battery, lubricating oil, a brake system (disc, pad, fluid) or the like as the maintenance state of the vehicle 10. A well-known technique can be used for the sensor 107. The maintenance state of the vehicle 10 is not limited to the above-described state obtained by the sensor 107, and the maintenance state of the vehicle 10 also includes information on the past maintenance state of the vehicle. In this case, when the vehicle 10 receives maintenance at a predetermined maintenance shop, the maintenance information is stored in the main storage unit 102. The prescribed maintenance shop may be a maintenance shop of a vehicle, or a car dealer or a vehicle part sales shop in which a maintenance shop is installed.

The position information obtaining unit 108 is a unit for obtaining the current position of the vehicle 10, and typically includes a GPS receiver or the like.

Next, the shop-side terminal 200 will be described. The shop-side terminal 200 is a personal computer (PC) connected to the server device 300 via the network N1 such as the Internet, which is a public communication network.

Similar to the on-board device 100, the shop-side terminal 200 includes a processor 201, a main storage unit 202, an auxiliary storage unit 203, a display unit 204, an input unit 205, and a communication unit 206. The processor 201, the main storage unit 202, the auxiliary storage unit 203, the display unit 204, the input unit 205, and the communication unit 206 are the same as the processor 101, the main storage unit 102, the auxiliary storage unit 103, the display unit 104, the input unit 105, and the communication unit 106 of the on-board device 100, and therefore descriptions thereof are omitted. In the shop side terminal 200, the input unit 205 may include a keyboard, a mouse, and the like.

### (Functional Configuration of Server Device)

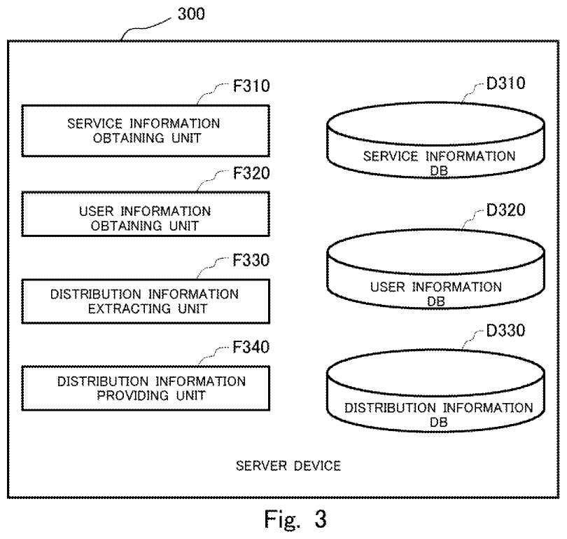

FIG. 3 is a diagram illustrating a functional configuration of the server device 300. The server device 300 includes, as functional components, a service information obtaining unit F310, a user information obtaining unit F320, a distribution information extracting unit F330, a distribution information providing unit F340, a service information database D310, a user information database D320, and a distribution information database D330. The processor 301 of the server device 300 executes the processes of the service information obtaining unit F310, the user information obtaining unit F320, the distribution information extracting unit F330, and the distribution information providing unit F340 by the computer programs in the main storage unit 302. However, any of the functional components or a part of the processing thereof may be executed by a hardware circuit.

The service information database D310, the user information database D320, and the distribution information database D330 are constructed by managing data stored in the auxiliary storage unit 303 by programs of database management systems (DBMS) executed by the processor 301. The service information database D310, the user information database D320, and the distribution information database D330 are, for example, relational databases.

It should be noted that any of the functional components of the server device 300 or a part of the processing thereof may be executed by another computer connected via the network N1. For example, the processing of the distribution information providing unit F340 and the processing of the services information obtaining unit F310, the user information obtaining unit F320, and the distribution information extracting unit F330 may be executed by separate computers.

The service information obtaining unit F310 obtains predetermined service information including advertisements (hereinafter, also referred to simply as “service information”). Then, the service information obtaining unit F310 registers the obtained service information in the service information database D310.

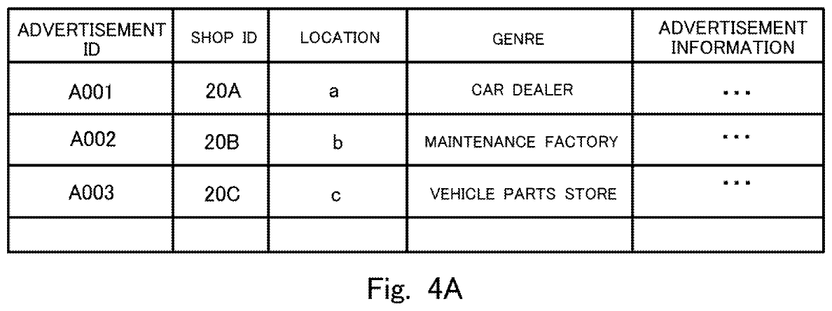

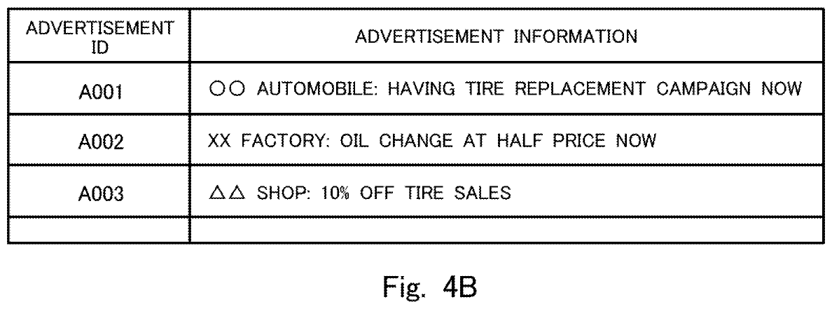

Here, the service information database D310 is a database that stores service information. The service information database D310 has a service information table shown in FIG. 4. The information stored in the service information table is not limited to the example shown in FIG. 4, and can be added, changed, or deleted as appropriate.

The services information table shown in FIG. 4A has fields of advertisement ID, shop ID, shop location, shop genres, and advertisement information. The advertisement ID is an ID for identifying the advertisement. The shop ID is an ID for identifying the shop which sends the advertisement, and the ID corresponds to the shops 20A to 20C shown in FIG. 1. The shop location is information relating to the location of the shop which sends the advertisement, and is, for example, location information of the shop. The shop genre is information on the genre of the shop that sends the advertisement. In the present embodiment, the shop 20A is a car dealer, the shop 20B is a maintenance factory, and the shop 20C is a vehicle parts shop. It is assumed that a maintenance department is installed in the shop 20A which is a car dealer and the shop 20C which is a vehicle parts shop. In other words, the shops 20A to 20C correspond to predetermined maintenance shops according to the present disclosure.

The advertisement information is exemplified by FIG. 4B. For example, the advertisement informations of the advertisement A001 sent by the shop 20A as a car dealer is “OO Motors Tire Replacement Campaign is being carried out”.

Such advertisement information is sent from the shop-side terminal 200 to the server device 300 by the shop clerk or the like of the shop inputting the information to the shop-side terminal 200. More specifically, the shop-side terminal 200 has a functional configuration that accepts input of service information including advertisements and transmits the input information to the server device 300. The processor 201 of the shop-side terminal 200 executes a process of transmitting the service information input from the input unit 205 to the server device 300 via the communication unit 206 by a computer program on the main storage unit 202. Then, the service information obtaining unit F310 obtains the information transmitted from the shop-side terminal 200.

Here, the explanation returns to FIG. 3. The user information obtaining unit F320 obtains predetermined user information (hereinafter, also referred to as “user information”) relating to the maintenance state of the vehicle 10 in which the user of the advertisement providing system 1 rides. Then, the user information obtaining unit F320 registers the obtained user information in the user information database D320. The maintenance state of the vehicle 10 is information that can be obtained by using the sensor 107, as described above. Alternatively, the maintenance state of the vehicle 10 is past maintenance information of the vehicle 10 that can be stored in the main storage unit 102.

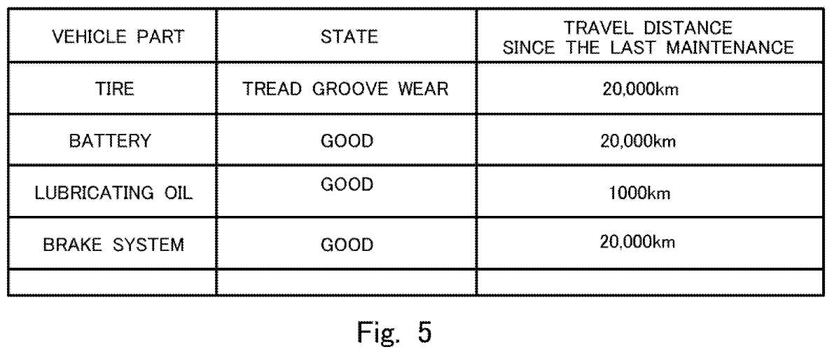

The user information database D320 is a database for storing user information. The user information database D320 has a user information table shown in FIG. 5. The information stored in the user information table is not limited to the example shown in FIG. 5, and can be added, changed, or deleted as appropriate.

The user information table shown in FIG. 5 has fields of a vehicle part in the vehicle 10, a state of the part, and a travel distance from the previous maintenance. In the present embodiment, the vehicle 10 has traveled 20,000 km since the last tire replacement, and the wear of the tire grooves is detected by the sensor 107. Then, the user information obtaining unit F320 obtains the wear of the tire grooves as the user information, and registers the wear in the user information database D320. In the user database D320, the states of the battery, the lubricating oil, and the brake system, all of which are good, are also registered.

Here, the explanation returns to FIG. 3. Based on the user information obtained by the user information obtaining unit F320, the distribution information extracting unit F330 extracts information matching the user of the vehicle 10 (hereinafter, sometimes referred to as “distribution information”) from the service information about the maintenance shop (shops 20A-20C) described above. Here, the distribution information is information that may be actually provided to the user among the service information. In other words, not all of the service information obtained by the service information obtaining unit F310 is actually provided to the user. This will be explained below.

The service information obtaining unit F310 obtains service information of not only the shops 20A to 20C shown in FIG. 1 but also all the shops using the advertisement providing system 1. If the service information obtaining unit F310 obtains a relatively large number of pieces of service information and all of the pieces of service information are provided to the user, the user may find out information desired by the user from among the large number of pieces of service information, which may be troublesome.

Therefore, the distribution information extracting unit F330 extracts the distribution information based on the user information. Then, the distribution information extracting unit F330 registers the extracted distribution information in the distribution information database D330.

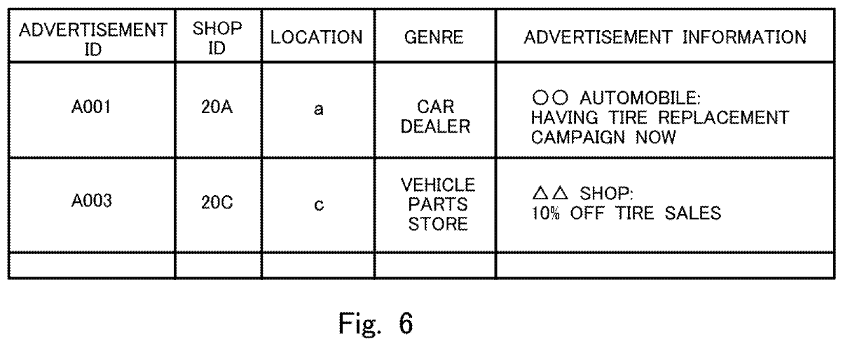

The distribution information database D330 is a database for storing distribution information. The distribution information database D330 has a distribution information table shown in FIG. 6. The information stored in the distribution information table is not limited to the example shown in FIG. 6, and can be added, changed, or deleted as appropriate.

The distribution information table shown in FIG. 6 has the fields of advertisement ID, shop ID, shop location, shop genres, and advertisement information, as in FIG. 4A above. In the present embodiment, as described above, the wear of the tire grooves has been obtained as the user information. In this case, the user of the vehicle 10 is required to replace the tire at a predetermined time in the future. Therefore, in order to prompt the user to replace the tire, the distribution information extracting unit F330 extracts, as distribution information, the advertisement A001 and the A003 having the advertisement information relating to the tire, as shown in FIG. 6.

If such information is transmitted from the server device 300 to the on-board device 100 of the vehicle 10, the information matching the user can be provided to the user. However, if the distribution information is simply provided to the user as it is, it may not sufficiently promote the user to be directed to the shop that sends the distribution information.

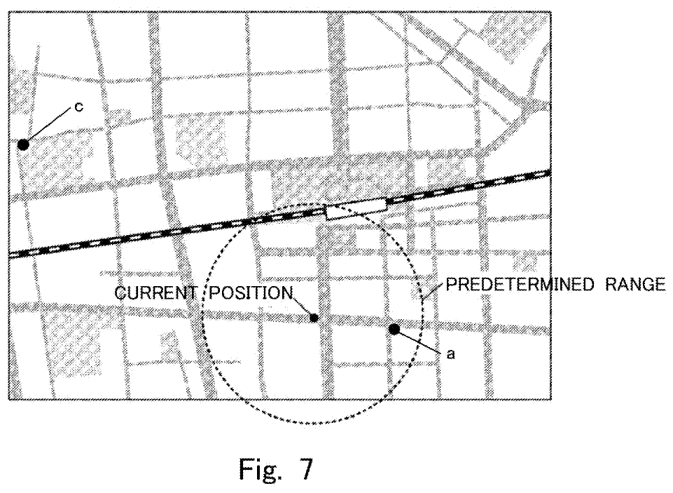

Therefore, as shown in FIG. 3, the server device 300 has a distribution information providing unit F340 as a functional component. The distribution information providing unit F340 transmits the distribution information to the on-board device 100 of the vehicle 10 based on the position information of the vehicle 10. This will be explained with reference to FIG. 7.

FIG. 7 is a diagram for explaining a maintenance shop, information of which is actually provided by the distribution information providing unit F340 among the maintenance shops that send the distribution information in the present embodiment. In the present embodiment, the distribution information providing unit F340 provides the user with the distribution information regarding the maintenance shop existing within a predetermined range from the current position of the vehicle 10.

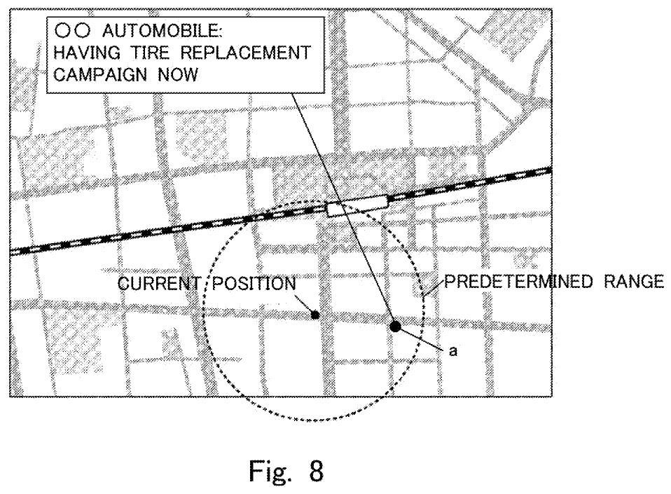

As described above, the distribution information extracting unit F330 extracts the advertisements A001 and A003 shown in FIG. 6 as the distribution information. Here, according to FIG. 7, it can be seen that the shop 20A existing at the location a belongs within a predetermined range from the current position of the vehicle 10. The predetermined range is an area which the user can relatively easily visit on the way to the destination, and is, for example, a range within 1 km from the current position of the vehicle 10. Then, the distribution information providing unit F340 provides the user with distribution information relating to the shop 20A. More specifically, the distribution information providing unit F340 executes a process of transmitting the distribution information relating to the shop 20A to the on-board device 100 via the communication unit 304. Then, the processor 101 of the on-board device 100 executes a process of displaying this information received via the communication unit 106 on the display unit 104 by the computer program on the main storage unit 102. FIG. 8 is a diagram illustrating an example in which advertisement information of an advertisement A001 sent by the shop 20A is displayed on a navigation screen included in the on-board device 100. According to this, the information that matches the user and that relates to the maintenance shop existing in the area which the user can relatively easily visit is provided to the user. As a result, it is promoted to direct the user to the maintenance shop that sends the distribution information.

On the other hand, according to FIG. 7, it is understood that the shop 20C existing at the location c does not belong to the predetermined range from the current position of the vehicle 10. Then, if the vehicle 10 attempts to move from the current position to the shop 20C, the user must move a relatively long distance. Therefore, the distribution information providing unit F340 does not provide the user with the distribution information relating to the shop 20C which does not belong to the predetermined range from the current position of the vehicle 10.

According to the advertisement providing system described above, it is possible to promote to guide the user to a maintenance shop that sends service information matched with the user.

### (Processing Flow)

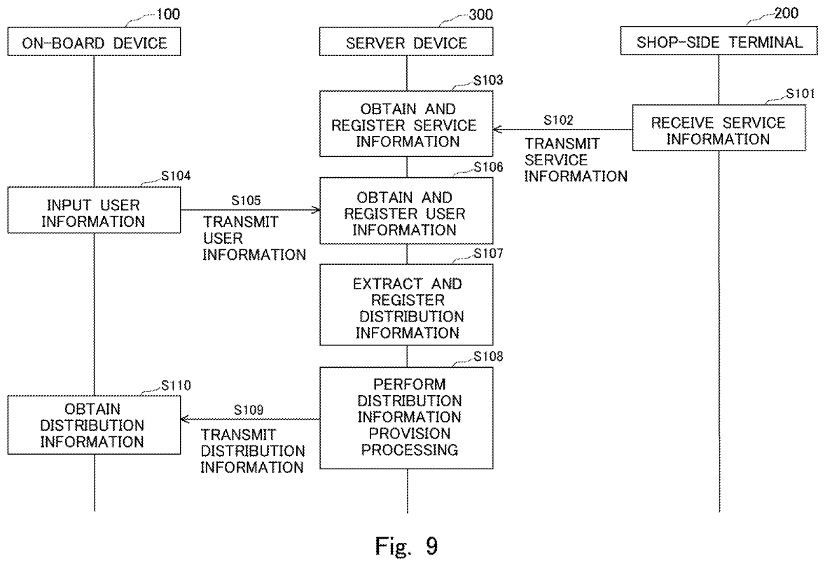

The flow of the operation of the advertisement providing system according to the present embodiment will be described. FIG. 9 is a diagram illustrating a flow of an operation of the advertisement providing system according to the present embodiment. FIG. 9 explains the flow of operations between the respective components and the processing executed by the respective components in the advertisement providing system 1.

The shop-side terminal 200 receives service information from a shop clerk or the like of the shop (S101), and transmits the service information to the server device 300 (S102).

The server device 300 obtains the service information transmitted from the shop-side terminal 200 via reception by the communication unit 304, and registers the service information in the service information database D310 (S103).

User data is input to the on-board device 100 (S104). In the present embodiment, in the S104 process, the maintenance state of the vehicle 10 is input by the sensor 107. Then, the on-board device 100 transmits the user information to the server device 300 (S105).

The server device 300 obtains the user information transmitted from the on-board device 100 via reception by the communication unit 304, and registers the user information in the user information database D320 (S106).

Based on the user information, the server device 300 extracts distribution information matching the user from among the service information about the maintenance shop, and registers the distribution information in the distribution information database D330 (S107).

Further, the server device 300 executes a process of providing the distribution information to the user (distribution information providing process) based on the position information of the vehicle 10 (S108). In the present embodiment, in the distribution information providing process, the server device 300 obtains the current position of the vehicle 10. Here, the server device 300 obtains the current position of the vehicle 10 by receiving the current position of the vehicle 10 obtained by the position information obtaining unit 108 and transmitted from the on-board device 100 via the communication unit 106. Then, in the distribution information providing process, distribution information to be actually provided to the user is selected from the distribution information registered in the distribution information database D330 so that distribution information about the maintenance shop existing within a predetermined range from the current position of the vehicle 10 is provided to the user, and the distribution information to be actually provided to the user is transmitted to the on-board device 100 (S109).

Then, the on-board device 100 obtains the distribution information transmitted from the server device 300 (S110).

### (Recording Medium)

A program for making a computer or other machine or device (hereinafter referred to as a computer or the like) realize any of the functions described above can be recorded on a recording medium readable by the computer or the like. The function can be provided by making a computer or the like read and execute the program of the recording medium.

Here, the computer-readable recording medium refers to a non-transitory recording medium in which information such as data and a program is accumulated by electrical, magnetic, optical, mechanical, or chemical action and can be read by a computer or the like. Among such recording media, there are, for example, flexible disks, magneto-optical disks, CD-ROM's, CD-R/W's, DVDs, Blu-ray disks, DATs, 8 mm magnetic tapes, memory cards such as flash memories, and the like. As a recording medium fixed to a computer or the like, there are a hard disk, a read only memory (ROM), and the like. Further, the Solid State Drive can be used as a recording medium detachable from a computer or the like, or as a recording medium fixed to the computer or the like.

### Second Embodiment

Next, a second embodiment of the present disclosure will be described. In the present embodiment, the detailed descriptions of the configuration and the control processing which are substantially the same as those of the first embodiment is omitted.

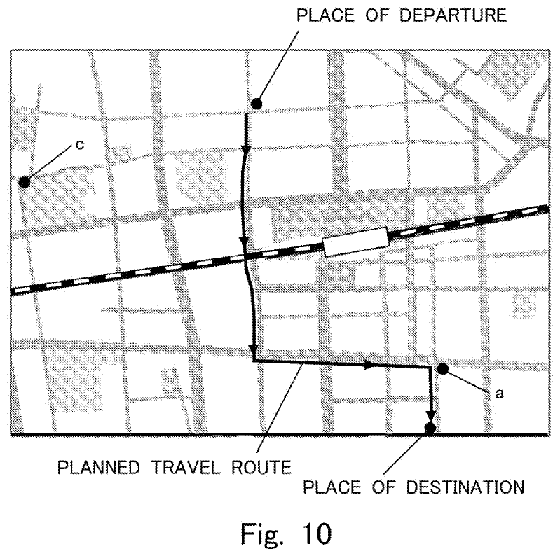

In the first embodiment described above, the distribution information providing unit F340 of the server device 300 provides the user with the distribution information about the maintenance shop existing within a predetermined range from the current position of the vehicle 10. On the other hand, in the present embodiment, the distribution information providing unit F340 of the server device 300 provides the user with the distribution information about the maintenance shop existing on the planned travel route of the vehicle 10 set in advance. This will be explained with reference to FIG. 10.

FIG. 10 is a diagram for explaining a maintenance shop, information of which is actually provided by the distribution information providing unit F340 among the maintenance shops that send the distribution information in the present embodiment. When the user inputs the departure point and the destination point into the navigation system included in the on-board device 100, the planned travel route of the vehicle 10 shown in FIG. 10 is set in advance.

According to FIG. 10, it can be seen that the shop 20A existing at the location a exists on the planned travel route of the vehicle 10. On the other hand, it can be seen that the shop 20C existing at the location c does not exist on the planned travel route of the vehicle 10. In this instance, the distribution information providing unit F340 provides the user with distribution information relating to the shop 20A. Then, the user can relatively easily visit the maintenance shop which sends the service information matched with the user on the way to the destination.

The above-described advertisement providing system can also promote to guide the user to the maintenance shop that sends service information matched with the user.

### Other Embodiments

The above embodiments are merely examples, and the present disclosure can be implemented by appropriately changing them within a range not deviating from the gist thereof.

The processes and units described in the present disclosure may be freely combined and embodied to the extent that no technical conflicts exist.

Furthermore, a process that is described to be performed by one device may be shared and performed by a plurality of devices. Processes described to be performed by different devices may be performed by one device. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. An information processing device including a controller comprising at least one processor configured to execute:
obtaining predetermined service information including an advertisement;
obtaining predetermined user information on a maintenance state of a vehicle in which a user rides;
extracting, based on the user information, distribution information which is the service information about a predetermined maintenance shop, and which matches the user among the service information; and
transmitting the distribution information to an on-board device of the vehicle based on position information of the vehicle.

2. The information processing device as set forth in claim 1, wherein
the controller transmits the distribution information on the maintenance shop existing in a predetermined range from a current position of the vehicle to the on-board device.

3. The information processing device as set forth in claim 1, wherein
the controller transmits the distribution information on the maintenance shop existing on a planned travel route of the vehicle set in advance to the on-board device.

4. An information processing method in which a computer executes:
a step of obtaining predetermined service information including an advertisement;
a step of obtaining predetermined user information on a maintenance state of a vehicle in which a user rides;
a step of extracting, based on the user information, distribution information which is the service information about a predetermined maintenance shop, and which matches the user among the service information; and
a step of transmitting the distribution information to an on-board device of the vehicle based on position information of the vehicle.

5. A non-transitory storage medium having a program stored thereon, the program being configured to make a computer execute:
a step of obtaining predetermined service information including an advertisement;
a step of obtaining predetermined user information on a maintenance state of a vehicle in which a user rides;
a step of extracting, based on the user information, distribution information which is the service information about a predetermined maintenance shop, and which matches the user among the service information; and
a step of transmitting the distribution information to an on-board device of the vehicle based on position information of the vehicle.
